(19) United States
(12) Patent Application Publication
(10) Pub. No.: US 2008/0270210 A1
(43) Pub. Date: Oct. 30, 2008

(54) SYSTEM AND METHOD FOR EVALUATING A REQUIREMENTS PROCESS AND PROJECT RISK-REQUIREMENTS MANAGEMENT METHODOLOGY

(75) Inventors: Theresa C. Kratschmer, Yorktown Heights, NY (US); Peter K. Malkin, Ardsley, NY (US); Padmanabhan Santhanam, Yorktown Heights, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/170,807

(22) Filed: Jul. 10, 2008

Related U.S. Application Data
(63) Continuation of application No. 11/330,538, filed on Jan. 12, 2006.

(51) Int. Cl. G06Q 10/00

(52) U.S. Cl. 705/7

(57) ABSTRACT

A system, method and computer program product for requirements management. Particularly, a requirements management scheme performs at least the following functions: 1) it guides a team through the requirements process and provides a structure for collecting “requests”. By using the scheme, team members are prompted to think about and record relevant information that will help clarify and complete requests; and, 2) the scheme allows users to use the attributes throughout the development process to identify risk and make improvements to their process. Many of these attributes can be refined during the development phase or even later. Besides helping team members achieve continuous improvement in their requirements process by providing a set of data and metrics for collection and assessment, the scheme enables an organization to effectively manage their requirements as well as manage changes to those requirements.

### CROSS REFERENCE TO RELATED APPLICATION

The present application is a continuation application of U.S. Ser. No. 11/330,538 filed Jan. 12, 2006, the entire contents of which are incorporated herein by reference.

### BACKGROUND OF THE INVENTION

1. Field of the Invention

The present invention relates generally to the field of product development and management of requirements to mitigate risk in those projects using metrics, analysis and risk assessment.

2. Definition of the Prior Art

The success of a product development organization depends on the ability of an organization to deliver a product that meets the needs and expectations of its customers, on time, and with acceptable quality. As schedules become tighter and the need for reduction of expenses increases, there is increased pressure for continuous process improvement to meet these demands. The management of requirements and associated risks are critical in meeting schedules and reducing costs. Development organizations collect a broad range of development data and metrics pertaining to requirements such as priority, expected effort and cost of implementation. Rarely, however, has this data provided the information necessary to simultaneously mitigate risk and provide feedback on qualitative and quantitative aspects of the development process.

For software products, managing changing requirements is a major challenge for software organizations. Teams acknowledge that they have problems with their requirements process that results in defects found both during development and by customers. In order to make improvements, analysts typically have to read through many requirements and do a root cause analysis to determine how they can improve their requirement process. This is a time consuming and complex task.

Over the years, there have been a number of efforts addressing the use of metrics for in-process project management (see, for example, D. Leffingwell and D. Widrig, Managing Software Requirements—A Unified, Approach, Addison-Wesley 2000 and, Jukka Kaariainen, et al., “Improving Requirements Management In Extreme Programming With Tool Support—an Attempt that Failed”, IEEE Computer Society, Proceedings of the 30th EUROMICRO Conference, 1089-6503/04). Generally, however, these teachings focus on specific sets of metrics captured during the requirements phase to help manage the priority of risk management. When discussing risk assessment, users are assessing the risk of a single requirement and the effect on the project if this requirement is not met. There is currently no systematic method that identifies specific metrics to be collected during the entire life cycle of a product and then uses those metrics to assess the risk of a collection of requirements.

One available product ParaSoft GRS (Group Reporting System)—provides a system for collecting metrics, e.g., software development metrics, for decision support. GRS automatically collects and correlates a variety of development data from multiple sources, including code activity, test results, code coverage, requirements, and corrected bugs. However, the metrics collected relate to test and are collected from their various test tools. These metrics, however, can be reported to various roles—testers, architects, project managers.

IBM's Rational® RequisitePro® solution is a requirements and use case management tool for project teams who want to improve the communication of project goals, enhance collaborative development, reduce project risk and increase the quality of applications before deployment. Features of RequisitePro® include: 1) customizable, filterable requirement attributes; 2) in-depth traceability and coverage analysis; and, 3) detailed change impact analysis with audit trails and email notification While RequisitePro® does come with certain attributes defined: priority, unique ID, for example, they are limited in number and users would have to develop their own queries. There is no link between queries of data and predefined tasks like “Evaluation Schedule and Productivity”. Analysis is performed for a single requirement and includes using use cases to model requirements.

TeleLogic DOORS®—provides a product that performs an analysis of a single requirement or certain groups of related requirements for completeness and correctness. There is no mention of attributes/metrics or analyzing relationships of these attributes to tasks users may want to perform to manage project risk. Users are primarily architects, developers, and testers while project managers and product managers would be an important user of RMM. The Telelogic DOORS®/Analyst™ provides an easy-to-learn, UML-based requirements modeling capability for drawing models, pictures, and diagrams inside DOORS®, one of the industry's leading requirements management tool. With DOORS®/Analyst™ textual requirements and models are automatically kept in-sync, and models are ‘baselined’ and stored with their requirements ensuring complete consistency and traceability of requirements.

These current programs do not provide a Requirement Management Methodology (RMM classification scheme) that collects metrics from requirements and use that data to provide information on a specific subject—e.g., evaluating workload and schedule or to indicate risk of the project.

Thus it would be highly desirable to provide a system and method that identifies metrics that are used to provide feedback to users regarding specific ways to improve the requirements and development process.

Further, it would be highly desirable to provide a classification scheme and associated analysis techniques to both assess risk of the project based on aggregate requirements data and provide feedback on improving the development process.

### SUMMARY OF THE INVENTION

In light of the foregoing problems, drawbacks, and disadvantages of the conventional systems, the present invention provides a requirements management system, methodology and computer program product which provides a classification scheme and associated analysis techniques to both assess risk of the project based on aggregate requirements data and, provide feedback on improving the development process.

The requirements management system, methodology and computer program product particularly provides the capability of identifying specific metrics to be collected during the entire life cycle of a product and then using those metrics to assess the risk of a collection of requirements. The requirements management system, methodology and computer program product further identifies metrics that are used to provide feedback to users regarding specific ways to improve the requirements and development process.

More particularly, a requirements management scheme has been developed to perform at least the following functions: 1) guides a team through the requirements process and provides a structure for collecting “requests”, By using the scheme, team members are prompted to think about and record relevant information that will help clarify and complete requests; and, 2) the scheme allows users to use the attributes throughout the development process to identify risk and make improvements to their process. Many of these attributes can be refined during the development phase or even later. Besides helping team members achieve continuous improvement in their requirements process by providing a set of data and metrics for collection and assessment, the scheme enables an organization to effectively manage their requirements as well as manage changes to those requirements.

According to a first embodiment of the invention, there is provided a requirements management system and methodology comprising:

automatically collecting requirements related data and metrics associated with one or more of user needs, features, and requirements;

classifying requirements related data and metrics according to one or more attributes and associated attribute values for storage in a memory storage device;

receiving user requests concerning a requirements topic; and,

in response to received user requests:

accessing the classified requirements related data from the memory storage device and analyzing relationships of attributes to one or more analysis task categories associated with a requirements topic; and,

providing information to the user according to a particular requirements topic based on results of the analyzing, wherein users are enabled to assess requirements and identify a course of action for improving requirements and the requirements process.

The requirements related data includes one or more attributes selected from: business impact, user needs, features, and requirements; customer importance and development priority of requirements related data; estimated and actual cost and effort of requirement; dependencies/conflicts between requirements, resources necessary for requirement (e.g., skills, hardware, time); creation date, freeze date, date of last revision, approval date; development skill type needed to implement; customer benefits of implementing requirement, qualifier (e.g., new, modification, enhancement, addition, deletion); type (e.g., business impact, user need, feature, software requirement); descriptor (e.g., function, non-functional, design constraint); stakeholder source; unique id; phase proposed, phase implemented, release implemented; difficulty, design impact, stability, and status.

Preferably, these attributes are captured throughout the lifecycle, from the beginning of the requirements phase through release of the product to the customer. Not only can the data be captured in seconds when done by the appropriate person and at the right time ill the process, but the analysis can be automatically performed in minutes with a data analysis tool, such as Rational Requisite Pro® and Rational ClearQuest® (both trademarks of International Business Machines, Corp. (IBM)), both publicly available. The analysis tasks that can then be performed in a matter of minutes using these attributes include, but are not limited to:

1) Evaluating return on investment
2) Assessing productivity and workload
3) Evaluating schedule
4) Identifying strengths and weaknesses in the requirements process
5) Understanding customers needs
6) Evaluating project management

By analyzing the requirements data, users are then able to identify areas for improvement in the requirements process. They also have the objective data they need to make current decisions regarding their management of requirements and evaluating the risk that changes to those requirements creates.

According to a further embodiment of the invention, there is provided a method of deploying a computer program product for managing requirements for a business entity comprising:

collecting requirements related data and metrics associated with one or more of needs, features, and requirements of the business entity;

classifying requirements related data and metrics according to one or more attributes and associated attribute values for storage in a memory storage device;

receiving requests from the business entity concerning a requirements topic; and,

in response to received request:

accessing said classified requirements related data from said memory storage device and analyzing relationships of attributes to one or more analysis task categories associated with a requirements topic; and,

providing information to the business entity according to a particular requirements topic based on results of said analyzing, wherein said subscribing entity is enabled to assess requirements and identify a course of action for improving requirements and the requirements process.

Advantageously, the requirements management system and method of the invention analyzes aggregate requirements, including non-functional and design constraint type requirements. Users that can extremely benefit from the requirements management system and method of the invention are project managers and product managers, as well as architects and ultimately customers.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts a block diagram of the computing system 10 in which the present invention is implemented;

FIG. 2 depicts the logic flow of the computing system according to the present invention;

FIG. 3 depicts the logic flow for the classification handler component;

FIG. 4 depicts the logic flow for the analysis handler component;

FIG. 5 depicts an overview of the control flow of the current invention;

FIG. 6 depicts an example of Analysis Tasks and Associated Questions/Titles;

FIG. 7 depicts an example of Questions/Title and Associated Requirement Attributes;

FIG. 8 depicts an example of a chart used in evaluating schedule evaluation, specifically the Frequency of Requirements and Open Date;

FIG. 9 depicts an example of a chart used in evaluating schedule evaluation, specifically the Open Date of Requirements for Month of June showing Design Impact and Priority; and,

FIG. 10 depicts an example of a chart used in evaluating schedule evaluation, specifically a drilldown chart showing Development Skill Types for Design Impact=High and Priority=1.

### DETAILED DESCRIPTION OF THE PREFERRED EMBODIMENTS

The present invention provides a system and computer program product implementing a Requirements Management Methodology (RMM) that provides a solution to help users or teams quickly and efficiently manage their requirements throughout the software life cycle. It provides a set of attributes to be used in the classification of requirements. These attributes are captured throughout the lifecycle, from the beginning of the requirements phase through release of the product to the customer. Collected information includes, but is not limited to: the date the requirement was created and implemented, the resources and skills that are needed to implement the requirements, the benefits the requirement provides to the customer, as well as effort, cost, and other information. Once this data is captured, it can be analyzed using a proper data analysis tool such as Rational Requisite Pro® and Rational ClearQuest® (both trademarks of IBM), both publicly available.

As will be described hereinbelow in greater detail, the attributes are collected for three types of “requests” to be tracked in the requirements process: User/Stakeholder Needs, Features, and Software Requirements. Requests may be new or a modification. The only criteria for using the RMM classification scheme of the invention are that requests are tracked and that attributes are assigned for them at the appropriate time.

As defined herein, User/Stakeholder Needs include the business or operational problem (opportunity) that must be fulfilled in order to justify purchase or use of the software; i.e., it describes the problem space, and results from answering questions including but not limited to: 1) What problem does the customer need to solve? 2) What is the customer trying to accomplish? 3) What is the customer's goal? By tracing each software requirement to a user need, the present invention eliminates, and at the least postpones, requirements that do not contribute directly to a well-defined and approved user/stakeholder need. Examples of needs include but are not limited to: Conduct business on the web; Increase presence in the market; Maintain inventory of parts; Generate reports summarizing findings; and Identify exposures in analysis.

As described herein, Features include that externally observable service provided by the system which directly fulfills a stakeholder need; i.e., it describes the solution space. Examples of features include but are not limited to: The car will have power windows; Defect-trending charts will provide a visual means of assessing progress; Web-enabled entry of sales orders; the camera will have a zoom lens; the sewing machine provides a touch-screen interface.

As described herein, Software Requirements describes the solution space in detail, i.e., specifies what the system needs to do. The high level design can be implemented once the software requirement has been clearly defined.

As a non-limiting example, a Stakeholder Need may include a customer requiring the ability to be able to conduct business on the web. Thus, one Feature may include the ability to enable users to view products in a catalog format. Accordingly, Software Requirements may include: the ability to display each product on its own page with image, price, description; and, the provision of buttons for providing functionality such as: adding to a cart, saving for later, deleting, etc. A further feature may include the ability to enable users to purchase products via the web using credit cards. Accordingly, Software Requirements may include: the ability to prompt users for credit card information to enable payment via American Express, MasterCard, Visa, etc; the ability that a purchase approval be rendered after validation of credit card information, for example.

As will be described in greater detail herein, the attributes that are created and captured in order to perform an assessment of the requirements process include, but are not limited to the following: Attributes which usually exist already such as: Unique id, date created, estimated effort; Attributes which are known but may not be captured explicitly such as: Type, qualifier, descriptor, phase proposed, stakeholder source, customer importance, freeze date, actual effort, cost, last change data, approval date, difficulty, design impact, stability, phase implemented, and status. Further Attributes to be captured by the RMM include: Customer benefit, development skill types, Requests for dependencies/conflicts, and Resource dependencies.

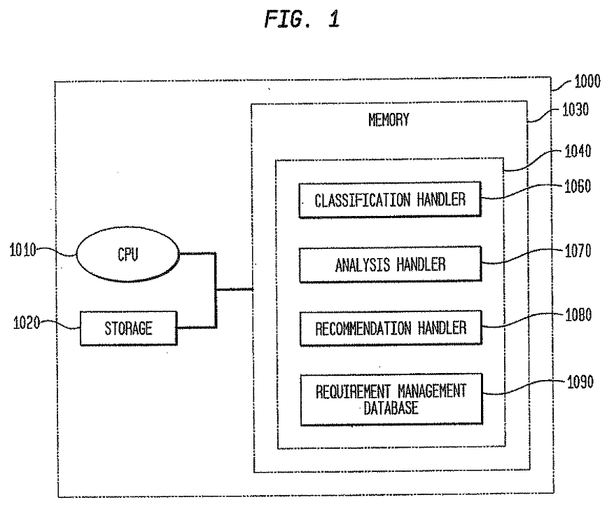

FIG. 1 depicts a block diagram of the computing system 1000 used in the preferred embodiment to provide the current invention. This server 1000 may comprise any computing node that is able to load and execute programmatic code, including, but not limited to: products sold by IBM such as ThinkPad® or PowerPC®, running the operating system and server application suite sold by Microsoft, e.g., Windows® NT, or a Linux operating system.

According to the present invention, as shown in FIG. 1, which is a computer assisted invention, server logic 1040 is preferably embodied as computer executable code that is loaded from a remote source (e.g., from a network-accessible database), local permanent optical (CD-ROM), magnetic storage (such as disk), or Storage 1020 into memory 1030 for execution by CPU 1010. As will be discussed in greater detail hereinbelow, the memory 1030 preferably includes computer readable instructions, data structures, program modules and application interfaces forming the following components: a Classification Handler 1060; an Analysis Handler 1070; a Recommendation Handler 1080; and a Requirement Management Database 1090. While the embodiment described is implemented in software, including but not limited to: firmware, resident software, microcode, etc., it is understood that the invention can take the form of an entirely hardware embodiment, an entirely software embodiment or an embodiment containing both hardware and software elements.

Furthermore, the invention can take the form of a computer program product accessible from a computer-usable or computer-readable medium providing program code for use by or in connection with a computer or any instruction executing system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system (or apparatus or device) or a propagation medium. Examples of computer readable medium include a semiconductor or solid state memory, magnetic tape, a removable computer diskette, a random access memory (RAM), a read only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

As shown in FIG. 1, the computer readable instructions, data structures, program modules and application interfaces forming the Classification Handler component 1060 has the responsibility of accessing the rules for classification, reading each record and assigning values for each attribute in the RMM classification scheme to that record. The Classification Handler then stores the user need, feature, or requirement along with the classified attributes into the Requirement Management Database 1090. The Analysis Handler component 1070 collects the classified data from the database, along with any other metrics pertaining to the set of records to be analyzed and performs the analysis. The Recommendation Handler component 1080 is responsible for identifying a set of recommendations for improvement based on the analysis of a specified subset of records.

The Requirement Management Database 1090 stores all three types of records—the user needs, features and requirements. It also contains the classified data for each record, the RMM classification scheme of attributes and values, the rules for analysis, the resulting analysis, the rules for recommended actions, and the actual recommended actions for a set of records. This database 1090 can include, but it not is not limited the DB/2 product sold by IBM. Skilled artisans will appreciate that the Requirement Management Database 1090 may include a service that runs on another server and is accessible by the preferred implementation's computer system 1000 via a network.

Skilled artisans will appreciate that the current invention can operate in a client server mode, standalone mode, or with multiple servers and clients. Any of the processes performed by the handlers 1060-1090, could also be processed manually by one or more people. A service organization, for example, may choose to review the analysis and then manually identify the recommended actions for improvement.

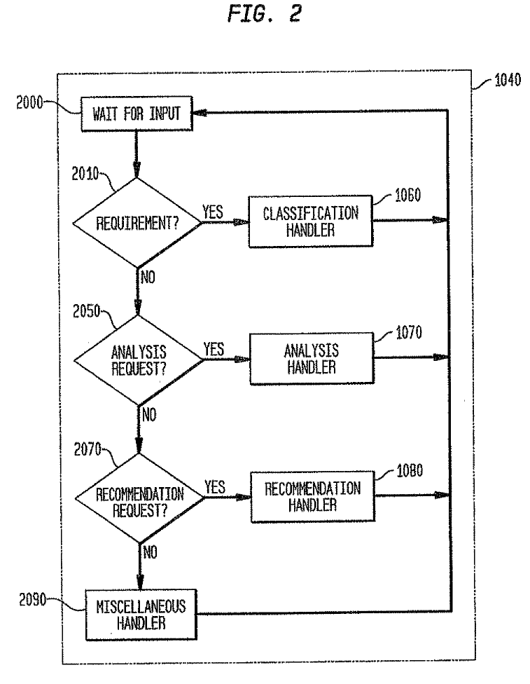

FIG. 2 depicts the logic flow of the computing system 1000. The memory 1040 contains the execution of the program once it has been loaded. Upon initiation of the program a loop is entered to wait for input 2000. Once input is received, its type is evaluated 2010. If it is a user need, feature, or requirement, it will be sent to the Classification Handler 1060 to be classified according to the RMM classification scheme. The Classification Handler 1060 includes functionality for accessing the rules for classification, parsing each record and assigning values for each attribute in the RMM classification scheme to that record. The Classification Handler 1060 then stores the user need, feature, or requirement along with the classified attributes into the database 1090. If the input was a request for analysis 2050, then the Analysis Handler 1070 collects the classified data from the database 1090, along with any other metrics pertaining to the set of records to be analyzed and performs the analysis. When a request for recommendations is received 2070, then the Recommendation Handler 1080 is responsible for identifying a set of recommendations for improvement based on the analysis of a specified subset of records. Finally, if the input is not a request for any of the above, then it is processed by the Miscellaneous Handler 2090 operating beyond the scope of the present invention.

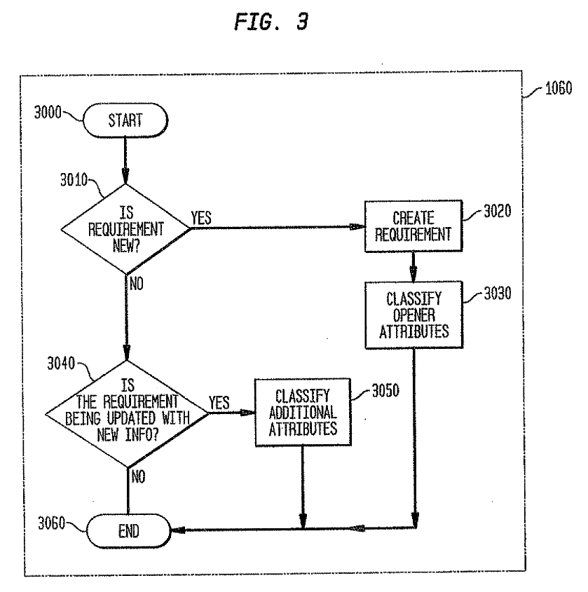

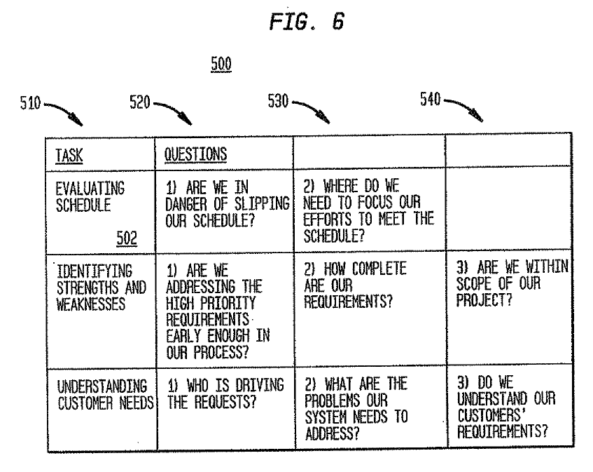

FIG. 3 depicts the logic flow executed by the Classification Handler 1060. When a requirement gets passed to the Classification Handler 1060 at step 3000, a determination is first made at step 3010 as to whether it is new. If the received requirement is new, then a new requirement is created at step 3020 in the Requirements Management Database 1090 by storing whatever details are available about the requirement. The requirement's opener attributes are then classified and attributes values assigned at step 3030 a process that will be described in greater detail with respect to FIG. 6. At that point, the classification handler ends at step 3060. Otherwise, returning back to step 3010, if it is determined that the requirement is not new, a further determination is made at step 3040 to determine whether the requirement is just being updated, e.g., due to additional information or because the status of the requirement has changed. If it is determined that additional information is being added or because the status of the requirement has changed, then the information (additional attributes) that are available are classified at step 3050; otherwise, the Classification Handler 1060 exits at step 3060. Once all information has been classified, the Classification Handler 1060 exits at step 3060.

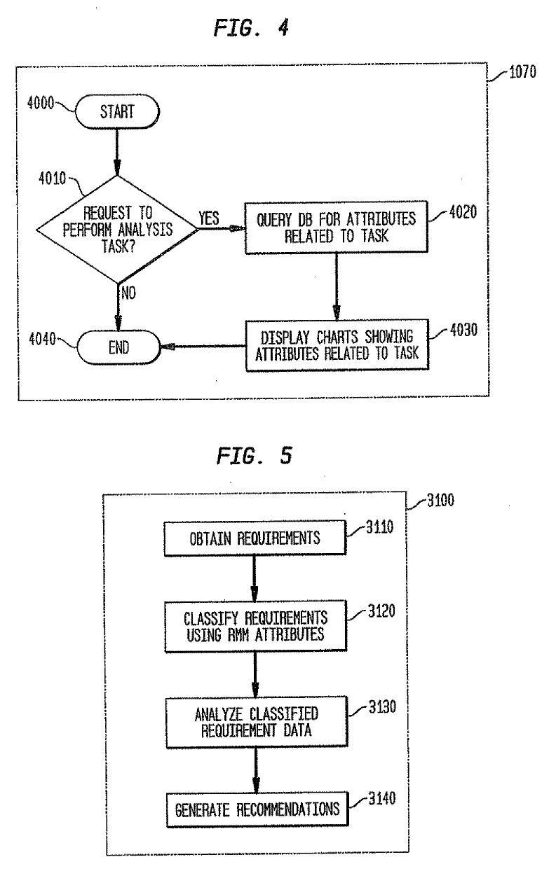

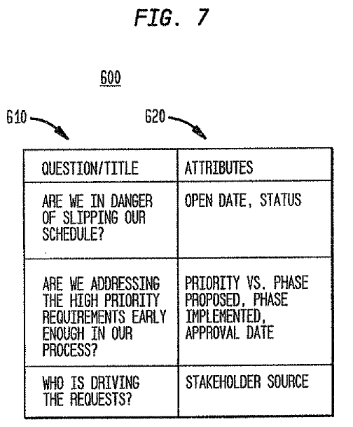

FIG. 4 depicts the logic flow for the Analysis Handler 1070. As indicated in FIG. 4, when the Analysis Handler 1070 is invoked at step 4000, a determination is first made at step 4010 as to whether a request has been received to perform an analysis task. As will be described in greater detail herein, an analysis task may be performed in a manner such as shown with the example analysis task performed and listed herein with respect to in FIG. 6. It is understood that the analyzed tasks are not limited to only those depicted in FIG. 6 as there are many different tasks that a user may wish to perform. If, at step 4010, it is determined that a specific task is requested, the process proceeds to step 4020, where the Analysis Handler 1070 queries the database 1090 for the data values for the attributes related to the questions associated for that task (see FIGS. 6 and 7). Next, the relevant data is displayed in a set of charts as depicted at step 4030 and the process terminates at step 4040. Once all charts are displayed, the Analysis Handler 1070 exits as indicated at step 4040. If at step 4010, it is determined that no request has been received to perform an analysis task the process terminates at step 4040.

The values that may be assigned for each of the above-identified attributes in the RMM classification scheme that are created and captured in order to perform an assessment of the requirements process according to the present invention are now described. Generally, in addition to values associated with each attribute there is additionally recorded at what time in the development the request is captured and, the implication of that request/requirement:

1. Unique ID—this attribute represents a unique identifier for the request and is used to identify unique requests. The captured data is classified when the requirement, feature, or user need is first created or opened.

2. Type—this attribute represents a type of request as defined above (i.e., User/Stakeholder Need, Feature or Software Requirement). The implication of capturing this attribute is to ensure that the request actually supports a particular feature and is the result of identifying a user or stakeholder need. Requirements that do not support a User Need or a set of User Needs that are intended to be targeted in a project can be given a lower priority for implementation. These Type attribute values are fixed and cannot be modified. The data is classified at creation of the request.

3. Qualifier—this attribute refers to type (e.g., was the request completely new, a modification, an addition (more detail) of an existing request, a repetition, or a deletion). Associated values are defined as follows: 1) New—a solicitation for a request that did not exist in any form in the past; 2) Modification (change request)—Changes or corrects an existing request-implications for regression testing; 3) Addition (enhancement)—Solicitation of an addition to an existing request; 4) Deletion—A solicitation to remove an existing request; and, 5) Repetition/Comparison—A solicitation that specifies a request should be repeated in its original form in a new project. For example, the usability in the next project should be as good as in the previous project; or, the customer shopping experience on the web is to be as good as the call center provides today. Generally, the Qualifier attribute assists in answering several questions such as: Have requirements been well-defined in the past? (For example, if the bulk of the requests are not new, then previous requests are being modified). This may indicate the previous requirements may not have been as complete (Addition) or clear (Modification) as they should have been. In addition, the testing-needed to be performed will be different for new requests versus modification of previous requests. A request to be deleted indicates a need that is no longer necessary and it is necessary to know why, e.g., in order to avoid spending to spend a lot of resources on requests that are short-term only. Requests that are repetitions or comparisons must be very clearly defined and tested. Often they lack detail and thus are not properly validated. These Qualifier attribute values are fixed and cannot be modified. The data is classified at creation time.

4. Descriptor—this attribute only pertains to features and software requirements. Associated values are defined as follows: 1) Functional—describes what the system will do; how it will behave; 2) Non-Functional express some of the attributes of the system or attributes of the system environment (usability, reliability, performance); 3) Design Constraints—impose limitations on the design of the system or the processes used to build that system; and 4) Business process (a requirement pertaining to a process to be followed rather than a requirements dealing with a software system or application). This attribute assists in the determination of types of design and testing necessary to implement the requirements. For example, “Use cases” are most appropriate when the system is rich in functionality and must support differing types of users, however, may not be as effective when applied to systems with few or no users and minimal interfaces, those with mostly non-functional requirements, and design constraints. By identifying the types of requests driving the system, the team will be better prepared to determine how to validate the system. These Descriptor attribute values are fixed and cannot be modified. The data is classified at creation or opening of the request.

5. Phase Proposed—this attribute represents when this request was proposed, i.e., in which phase was this request introduced. This may be customized for each project according to the phases actually used during software development. Example software development phases include, but are not limited to:
a) Defining Stakeholder and User Needs/Business Requirements Review—describes the part of the software life cycle when the team is soliciting and identifying the Stakeholder Needs and accurately describing the problem to be addressed by the system;
b) Identifying Feature/System Requirements Reviews—Describes that part of the life cycle when the team is defining the solution space;
c) Specifying Software Requirements—A requirement describes a condition or capability to which a system must conform;
d) High Level/External Design—Specifies the functionality and interfaces;
e) Low Level/Internal Design—Specifies how the functionality and interfaces will be implemented;
f) Coding—Translating design into code;
g) Unit Testing—The type of testing where a developer (usually the one who wrote the code) proves that a code module (the “unit”) meets its requirements;
h) Function Testing—Testing execution as an end user would based on external specifications of functionality;
i) System Testing—Testing using the all resources as would be found in the customer's environment;
j) User Acceptance Testing—Final testing of the system to make sure it conforms to requirements; and,
k) Production—The product has been released to customers.

Because late arriving requirements is one reason that there are many difficulties delivering what is promised by the customer, it is necessary to track when the requirements arrive so that it can be decided whether to accept them and what their priority should be. These Phase Proposed attribute values can be customized for a project/team. The data is classified at creation time/opening.

6. Date Created—this attribute refers to the date the requirement was created and entered into the requirements tracking system. Thus the RMM data collection system is able to track how late in the software development process requirements are being received and entered for the current project. The data is classified at creation time/opening.

7. Stakeholder Source—this attribute refers to which stakeholder this request came from and may be customized depending on the product. Example stakeholders include but are not limited to:
a) Customer—The request is from a paying customer. That customer could be internal or external;
b) Authorized representative of customer/funding source—The request did not come directly from a customer but from an authorized representative;
c) Project team member—Often project team members submit requests, however, it is imperative that, as a result, no “scope creep” results, i.e., the size/scope/effort of the project do not grow unintentionally.
d) Other project representative—Another project needs something done by this project for overall success;
e) Sources without funding—This represents other sources which have authority for providing requirements without funding. Examples are Executive customers without a wallet;
f) A corporate Strategic directive—representing the implementation of some strategic directive—may pertain only to development labs; and,
g) Adherence to standards—pertains more to development labs.

The Stakeholder source provides information to assist in the evaluation of whether business targets are likely to be met. For example, it may need to be determined if the ratio of funded to unfunded requests is appropriate. If not, some of the requests may have to be reprioritized. These Stakeholder Source attribute values can be customized for a project/team. The data is classified at creation of the request.

8. Customer/Stakeholder importance—this attribute refers to the importance of this requirement to the customer/stakeholder as compared to the other requirements submitted by this customer/stakeholder in this project. Example Customer/Stakeholder importance values include but are not limited to:
a) Critical—It is absolutely imperative that the request be implemented in the project;
b) Important—The request should be implemented unless there is a good reason not to;
c) Nice to have—The request should be implemented if resources allow; and,
d) No longer needed—At some time in the past, someone thought this request was important enough to create it. However, it has been subsequently determined that it is no longer needed by the customer.

The determination of how high the customer satisfaction level likely to be is dependent upon whether that customer's needs are being satisfied and whether the functionality that the customer is expected to deliver is being delivered. Thus, a first step is to find out which request(s) is(are) the most important to the customer. Given limited resources, the customer must be committed to the product being delivered. This will also be important in allocating resources and minimizing risk. The critical requests should be reviewed and investigated early in the development cycle to ensure the correct and complete product is delivered to the customer. The Customer/Stakeholder importance attribute values can be customized for a project/team. Some of the issues presented by capturing the Customer/Stakeholder importance attribute include: 1) When there is only one stakeholder for all the requests in a given project, then it is fairly straightforward to get the relative value of importance of all the requests. However, if there is more than one customer, it is difficult to evaluate requests across multiple sources. Thus, what is desirable to be captured in this attribute, is how important the request is to the stakeholder that submitted it—regardless of requests from other stakeholders. By using customer importance and priority together, the development team can look at all requests for a given project and rank them appropriately; and, 2) If there are multiple stakeholders ranking the same request, there are two possible solutions: i) Average the importance from the multiple stakeholders. This could be risky, however, since the fact that a valued customer ranks a request as “critical” may be lost while less important customers rank it as a “nice to have”, for example. Weighting the values may implemented to circumvent this, however; or ii) capture a frequency for importance. This means, for example, capturing the fact that three customers rank the request as “critical” while four customers rank it as a “nice to have” etc. However, in such a case, it is assumed that the functionality of the tool has been modified to capture the frequency even though they may allow input of multiple values. The data is classified at creation.

9. Customer Benefit—this attribute may have values referring to one or more benefits that the customer will see as a result of completing this request, once the requirement is implemented (noting that customers may be internal or external). The requirement addresses functionality that provides:
Usability—the ease of use or user friendliness;
Maintainability of Code—the ability of the system to be easily modified;
Efficiency/Cost—the ability of the system to perform its intended function with a minimum of resources;
Hardware Configuration—the ability of the system to integrate with external software products, applications, or hardware;
Software Configuration: the ability of the system to integrate with external software products, applications;
Integration with Legacy systems: the ability to integrate with code or systems that continue to be used because of the cost of replacing or redesigning it and often despite its poor competitiveness and compatibility with modern equivalents. The implication is that the system is large, monolithic and difficult to modify;
Security—the protection of systems, programs, and data from inadvertent or malicious destruction, alteration, or disclosure;
Privacy—the ability of the system to minimize the collection of personally, identifiable information;
Safety—the ability of the system to protect against injury or death.
Standards and Controls/Auditability—the ability of the system to comply with established pertinent standards and controls;
Robustness/Error Recovery—the ability of the system to recover gracefully from the exceptional inputs and situations in a given environment;
Performance—adequate speed of the system as perceived by the customer and the customer's end users, in terms of the ability to perform their tasks;
Scalability—the ability for a solution to work when the size of the domain increases;
Installability—the ability of the customer to prepare and place the system in position for use;
Maintenance—ease of applying preventive or corrective fixes to the system;
Serviceability—the ability to diagnose failures easily and quickly, with minimal impact to the customer;
Migration—ease of upgrading to a current release, particularly in terms of the impact on existing customer data and operations. This would include planning for a migration, where a lack of adequate documentation makes this task difficult. It would also apply in those situations where a new release of an existing product introduces changes affecting the external interfaces between the product and the customer's applications.
Documentation—that the publication aids provided for understanding the structure and intended uses of the system are correct and complete;
Availability/Reliability—the ability of the system to minimize interruption to service;
Accessibility—that successful access to information and use of information technology is provided to people with disabilities;
Cacpability/functionality—the ability of the system to perform new functions;
Testabilility—the ability to ensure that the expected behavior matches the actual behavior of the system;
Consumability—a customer-centric term that describes customers' experience with products. Highly consumable products enable customers to achieve fast time to value, get their solutions up and running quickly on our software, and deal simply and effectively with product maintenance throughout the product lifecycle. This will lead to delighted clients, which in turn leads to strong references, repeat business, and revenue growth.
   This attribute will be used in many different ways including, for example: 1) if a requirement specifies a particular area, e.g., security, ability is provided to pull all other requirements that impact customer's security and determine if those have to be modified as well; 2) this attribute will provide a checklist for the requirement to make sure that the various areas that need to be included which will help meet the customer's expectations, be clearly defined. In addition, this will encourage requests to be processed in groups rather than as separate entities. The data is classified at the creation or opening of the request.

10. Priority—this attribute captures the importance of the request from the view of the project team. It specifies the general order or time of implementation for this request within the release or project and takes into consideration the following: the request in relation to all other requests for the project; the customer importance of the request from one or more customers; the schedule for delivery of the system; and, resources, Example values for the Priority attribute include, but are not limited to:
High—This request should be implemented in this project;
Medium—If all the high priority requests have been implemented, then this request should be considered for inclusion in the project before those with a value of “Low”;
Low—If all the high and medium priority requests have been implemented, then this request may be considered for inclusion in the project;

Priority will be used for scheduling work to be completed. It can also be used when difficult decisions need to be made as to which requests will have to be postponed to later projects. These Priority attribute values can be customized for a project/team. The data is classified after brief review of the requirements. During this review, the requirements will be evaluated for feasibility, effort, and relevance to the product to be delivered.

11. Request Dependencies/Conflicts—this attribute captures the dependencies among the different requests from the customers to highlight any design or implementation consideration that warrants evaluation of conflicts or commonality. This field needs to be captured as traceability in Requisite Pro, across User Need, Features and Software Requirements. The collected information will be in the form of ID(s) representing User Need(s), Feature(s) or Software Requirement(s). Capture of this attribute is especially important in managing changes to requirements. That is, having this attribute will ensure that when a change is made to one request, all other related requests are also reevaluated. In addition, it provides an indicator as to the risk of changing a specific request and help determine resources needed for implementation. The conflicts will help in managing risk early on in a software product development cycle. The data is classified during investigation of the request. During this investigation, details will be provided that indicate the resources required to implement and test the requirement.

12. Resource Dependencies—this attribute captures what resources must be acquired in order to implement this request. Notwithstanding the dependency on people, teams, skills, time, and stakeholder buy-in, additional values to be taken into account include-
Hardware—printers, networking hardware, chips, etc.; 3rd party packaged Software—software developed externally (e.g., software bought off the shelf);
Other Applications/Components—applications or components developed internally that do not fall into the category of 3rd party software;
People/Team/Skills—internal or external;
Time/Date—the requirement must be implemented by a particular date, for example, to get critical market share;
Access to information systems—user ids, security clearance;
Data—in order to implement the requirement, a particular data set must be obtained;
Environment—clean environment for test—cleaning up from previous projects (project dependency);
Stakeholder buy-in—commitment from stakeholder for any required resources;

Translation of materials—translation of materials from language to another; and,

Invention is Required—new technology must be invented or implemented.

Resource dependencies assist the development team in managing risk. By identifying critical obstacles and resources, those areas may be targeted as soon as the requirement is created. These Resource dependencies attribute values can be customized for a project/team. The data is classified during investigation.

13. Development Skills—this attribute specifies the development team skills required to implement the request. In order to satisfy this request, the developers need to implement or work with one or more of the following:
Data Mining—analysis of data in a database using tools that look for trends or anomalies without knowledge of the meaning of the data;
Data processing—manipulation, cleansing, adhering to standards;
Refactoring/Restructuring—Improving software by reorganizing its internal structure without altering its external behavior;
Software Interfaces: Development of APIs, Messages, etc.;
Hardware Interfaces: Development of hardware device drivers, hardware configuration management tools, etc.;
Legacy code/architecture; Working with legacy codes from same or other platforms (OS, Middleware, DB, etc);
Robustness/Error Recovery—improving the way the system responds to errors;
Reuse—Using code developed for one application in another;
Porting—Translating software to run on a different computer and/or operating system;
Emerging Technology≠pertains more to product divisions and gaining market share using a particular technology/platform/software/hardware;
Documentation—creating or enhancing user guides, help text, or other publication aids;
Business Process Related—improving the way the business is run;
User—centered design—Customer facing input, output interfaces, considerations;
Design patterns—Exploitation of existing (e.g., e-Business) design patterns for rapid development;
Testing e.g., including but not limited to potential development skills such as: Architecture and Technology (A&T), Configuration and Installation, Reporting, Distributed Computing, Database Programming, Graphics Intensive Embedded Programming, Modeling, API Design, Concurrent Computing, Limited Resource Devices, Data Structure and Algorithms, Infrastructure, and, Security and Authorization. The list does not have to be limited to these, however, and can be customized by the software development team to capture relevant information for their product and team.

This attribute is useful in determining resources and skills for the implementation of the requirement. It can also be used when looking at the patterns for requirements to determine a process for implementing and validating them. For example, if several requirements related to re-factoring are requested, they can be grouped and then assigned for implementation together. In addition, test cases can be developed accordingly. The attribute can also be used in tracking the requirement to subsequent defects where it can provide information on areas that the developers need to improve either through education or adhering to process in order to implement their requirements more effectively. The data is classified during investigation.

14. Freeze date/lock down period/lock scope—this attribute refers to the date after which no more changes should occur to the definition or refinement of the requirement. Implementation addresses the question of “How much change is occurring after there is supposed to be no more change?” This will be a good predictor of success. For example, if changes are initiated after the freeze date, additional risk may be introduced into the product. That may also indicate that the requirements are not as clear and complete as had been originally thought. The data is classified during investigation.

15. Estimated Effort—this attribute addresses the question “What is the estimated effort for implementation of this request?” and associated values will become more granular as the project develops from user need (e.g., problem domain) to feature to requirement (e.g., solution domain). The size value for this attribute can be determined by the team but should be consistent. The size value for this attribute is used to establish priority, estimate workload, and calculate cost. The data is classified during investigation.

16. Actual Effort this attribute addresses the question “What is the actual effort for implementation of this request?” This value will be compared with estimated effort. The effort for this can be determined by the team but should be consistent. The actual effort will be compared with estimated effort to assess team's ability to schedule work. The data is classified during investigation.

17. Cost—this attribute refers to the real cost of implementing the request and is used in evaluating workload and schedule and allocating resources. The data is classified during investigation.

18. Latest Revision Date—this attribute refers to the date a last change was implemented and is important for comparison against the freeze date to find out how much activity is still going on with this request after it was supposed to be frozen. While this may indicate risk and identify areas in the process that need improvement. If changes are occurring after the freeze date or late in the cycle, there may exist exposures. In requests that are co-dependent, this attribute can also be used to signal work still needing to be done if change dates do not correspond to each other. The data is classified when the requirement has been tested for accuracy by the testing team

19. Approval date—this attribute refers to a date this request was approved for implementation in the project. Again, the date the request is approved will be an indicator of risk and exposures. For example, requests with late approval dates may put a project at risk. Thus, the resources and process may have to be evaluated if there are many requests with late approval dates. The data is classified when the requirement is approved for inclusion in the specified release by the board that is responsible for evaluation of requirements.

20. Difficulty—this attribute addresses the question “Flow difficult will it be to implement this feature/requirement?” This attribute takes into account several different factors: technology, skills, schedule, and team. This attribute may take on values including:
High—Very difficult to implement;
Medium—Moderately difficult to implement; and,
Low—Not difficult or easy to implement.

This will be used to assign a priority to the request. In combination with implementation type, it can also be used in evaluating workload and assigning resources. The data is classified when approved for inclusion of the requirement into the specified release.

21. Design Impact—this attribute addresses the question “What is the impact on design of the system?” or “Which areas will have a major impact on design if changes occur?” This attribute may take on values including:
High—The request will have a major impact on the design of the system due to resources, dependencies, or interfaces;
Medium—The request will have a moderate impact on design; and,
Low—The request will have no significant impact on the design of the system.

This is another attribute that will help in allocating resources and mitigating risk. Those requests with a high impact on design can be evaluated early on in the development cycle so a process may be put in place and resources assigned to lessen the possibility of problems later on. This attribute will also play an important role in prioritizing requests when there are too many for the resources currently in possession. For example, those with a high design impact may have to be moved to a later release, if they are received too late in the design cycle. The data is classified when approved for inclusion of the requirement into the specified release.

22. Stability—this attribute indicates how well defined and clear the request is; how unlikely to change, the request is, during the development of this project. This attribute may take on values including:
High—It is unlikely the request will change;
Medium—It is likely that the request will change somewhat;
Low—It is highly likely there will be changes to the request.

This attribute can be used to calculate risk, assign priorities, and evaluate the readiness of the request to move to the design phase. Requests that have high stability can proceed to design and implementation while those with low stability may need more work or customer involvement. The data is classified when approved for inclusion of the requirement into the specified release.

23. Phase implemented—this attribute indicates in which phase of the software life cycle was this requirement implemented. By implementation it is meant in which phase the request was included in a build and ready to be tested. This will be customized for a given project. This attribute will be very important in identifying risk and exposures. Requests with certain attributes (high criticality, high design impact, many dependencies) may be very risky to accept in later phases. This Phase implemented attribute has values that may be customized by a project/team. The data is classified during testing of the requirement to ensure it behaves according to the specifications.
24. Status—this attribute indicates the current state of the request. Example Status attribute values include, but are not limited to:
Under investigation/elaboration—Investigation or elaboration refers to the process of eliciting enough detail that the requirement becomes clear and complete and can be transferred to the high level design phase;
Approved for implementation in this project—the request has been accepted for inclusion into the project;
Incorporated in design—the request has been designed, coded, and documented;
Validated—the request has been successfully tested;
Rejected—the requirement was not accepted either after a brief review or after investigation;
Postponed—the request will not be implemented in the current project but will be postponed to a later project;
Closed—all work on the requirement has been completed.

The Status attribute values will be used to track the requirements and measure progress. By looking at the status of the requests at any given date along with other attributes, it can be assessed whether the development team is on schedule and are making progress. This Status attribute has values that may be customized by a project/team and its data is classified throughout the development process. That means the status will change as the state of the requirements changes throughout the development cycle.

25. Business Impact—this attribute indicates the value of the requirement to the business including, but not limited to, whether it: Improves short term business performance; Creates opportunities for future business growth and innovation; Improves business unit operational performance; Reduces business costs; Improves the value of a business's product or service; Improves the business's audit position; Meets operational demands; Improves IT flexibility to meet business needs; Reduces ongoing IT costs; Reduces software maintenance costs; Works with the existing infrastructure; Is easy to integrate with applications; Increases ROI of existing applications; Reduces time to value of the IT project; and Reduces IT project integration costs. The data is classified at creation time.

26. Release Number—this attribute refers to the release of the requirement.

FIG. 5 depicts an overview of the control flow of the current invention. The application 3100 will first obtain the user needs, features, and requirements as indicated at step 3110. Then, the application classifies these records using the RMM attribute and values as described herein and as indicated at step 3120. Next both classified data and any other metrics in the record will be stored in the database 1090 (FIG. 1). When there are enough records to warrant analysis, then all attributes and values pertaining to the records will be retrieved from storage and analyzed. The Analysis Handler component 3130 takes the classified data as input along with rules specifying the relationship between attributes and task categories. These rules also specify a question to guide assessment of each chart. The question will serve as a title for each chart. A task category may have one or more questions/titles. It then performs the analysis for each of those categories based on the classified information.

For example, based on the rules implemented for the classified data, a chart may be generated that addresses a question or concern posed by a user (e.g., a project manager) to guide assessment of a task category. For instance, for an analysis task/category “Evaluating Productivity/workload”, a set of charts will be generated that address questions (and indicate related classified attributes) such as:
A1) How much interdependency is there between requirements? (type, dependencies)
A2) Which requirements can be worked on in isolation? (software req, dependencies, design impact, approval date)
A3) Which requirements do I need to modify if I add major piece of functionality for security? (customer benefit security)
A4) Which features (and how many) can I postpone to a later release?priority, status)
A5) What types of requests (new feature, enhancement request, etc.) are driving the system (type, qualifier) definition.
A6) Do we need to fix the current functionality or add new functionality? (type, qualifier)

In another example analysis task/category “Evaluating Schedule”, a set of charts will be generated that address questions (and indicate related classified attributes) such as:

B1) Are we in danger of slipping the schedule? (create date, status)
B2) Where do we need to focus our efforts to meet the schedule? (design impact and priority where status=open)
B3) Where do we need to focus our efforts to meet the schedule? (estimated size and stability where status=open)
B4) How much unexpected change is still occurring? (freeze date and (status OR last change date))
B5) Which requirements are behind schedule? (create date, approval date)

In another example analysis task/category “Identifying Strengths and Weaknesses in the Requirements Process”, a set of charts will be generated that address questions (and indicate related classified attributes) such as:
C1) How complete are our requirements? (clarity—# changes, qualifier)
C2) How can we improve the requirements process? (phase proposed, type; phase imply, type)
C3) Are we addressing the high risk requirements early enough in our process? (priority, phase proposed, phase implemented, approval date)
C4) Did we freeze requirement prematurely OR Are changes occurring after my freeze date? (freeze date, date of last change, approval date)
C5) Are we within scope of our project? (phase implemented, priority)
C6) If I get a change request to modify one requirement, what other requirements need to be modified based on the dependencies we've established? (type, dependencies)

In another example analysis task/category “Understanding Our Customers' Needs”, a set of charts will be generated that address questions (and indicate related classified attributes) such as:
D1) Who is driving the requests? (stakeholder source)
D2) Do our requirements meet the expectations of our customers? (customer importance, priority)

D3) Do we understand our customers requirements? (customer benefit, type)
D4) What are the 6 requirements that are most important for us to implement most innovative? priority, customer benefit)

D5) Which requirements are affecting legacy code? (requirements, customer benefit=legacy)

D6) What are the problems our system needs to address (user needs-report)?

In another example analysis task/category “Evaluating Project Management”, a set of charts will be generated that address questions (and indicate related classified attributes) such as,
E1) What sort of system do we need to build? What sort of requests are driving our system? (descriptor)
E2) What sort of skills do we need to build this system? (implementation type, difficulty)
E3) Where do we need to focus to manage risk due to resources? (resource dependencies)
E4) Are we within scope of our project? (cost)

The following Table 1 displays one example list of how the attributes can be used to assess tasks. It is understood that this list is for exemplary purposes and is not a finite list. There are many different ways one could look at attributes both alone and in combination with other attributes to provide a user with information about the requirements process and how it affects a product. In the table below, the following is noted: Attributes designated with a “*” are currently captured in commercially available tool (e.g., Requisite Pro software tool); Assessment questions are described hereinabove with respect to questions A1)-E4) that are potentially treated in generated display charts; the “When Captured” values designating “→” indicates that the attribute may be captured or updated in additional phases as well; and, Use Cases are Functional Requirements—supplementary requirements comprise non-functional and design constraints. The list provided in the table below is just one possible view.

TABLE 1

| | | | | Requirements | |
|---|---|---|---|---|---|
| | | | | (Use Cases and | |
| | Who will provide | User | | Supplementary | When |
| Attribute | the information? | Needs | Features | Requirements) | Captured |
| 1. *Unique ID | System analyst | X | X | X | Created |
| 2. Type | System analyst | X | X | X | Created |
| 3. Qualifier(dep on type) | System analyst | | X | X | Created |
| 4. Descriptor | developer | | | X | Created |
| 5. Phase Proposed | System analyst | | X | X | Created |
| 6. Date Created | System analyst | | X | X | Created |
| 7. Stakeholder Source | System analyst | X | X | X | Created |
| 8. Customer/Stakeholder | Customer or | X | X | X | Created |
| Importance | customer rep | | | | |
| 9. Customer Benefit | | X | X | X | Created |
| 10. *Priority | Developer | X | X | X | Brief Rev. |
| 11. Request | System | X | X | X | Investigate |
| Dependencies/Conflicts | analystldeveloper | | | | |
| 12. Resource | Developer | | X | X | Investigate |
| Dependencies | | | | | |
| 13. Development Skill | Developer | | | X | Investigate |
| Type | | | | | |
| 14. Freeze Date | Project Manager | | X | X | Investigate |
| 15. Estimated | Developer | | X | X | Investigate |
| Effort/Size | | | | | |
| 16. Actual Effort/Size | Developer | | | | |
| 17. *Cost | System analyst | | X | X | lnvestigate |
| 18. *Latest Revision | Developer | | | X | Validated |
| Date | | | | | |
| 19. Approval Date | System analyst | | X | X | Approved |
| 20. *Difficulty | Developer | | X | X | Approved |
| 21. Design Impact | Developer | | | X | Approved |
| 22. *Stability | Developer | | X | X | Approved |
| 23. Phase Implemented | Developer | | | X | Incorp |
| | | | | | Design |
| 24. *Status | All | X | X | X | Throughout |
| 25. Business Impact | marketing | X | X | X | Creation |
| 26. Release | Architect | X | X | X | Creation |

Finally, returning back to FIG. 5, as shown at step 3140, a set of recommendations will be generated based on the analysis.

For example, recommendations might include the following:
1) Implement only those requirements with customer importance of 1 and 2;
2) Obtain hardware resources; and
3) Obtain development skills in software configuration and legacy systems.

FIG. 6 is a diagram 500 describing three possible analysis tasks in a column 510 and the types of charts that may be generated in corresponding columns 520, 530, 540 based on the selected analysis category. If the user selects the example analysis task/category “Evaluating Schedule” 502, a set of charts will be displayed each having the corresponding addressed questions title, e.g., “Are we slipping our schedule?” or “Where do we need to focus our efforts to meet the schedule”. By interpreting the data displayed on these charts, these questions can then be answered and the schedule can be evaluated.

FIG. 7 is a diagram 600 depicting the relationship between the titles on the charts (addressed Questions/Title) as shown in a column 610 and their associated requirement attributes to be displayed on each chart as shown in a column 620. For example, if the user selects the example analysis task/category “Evaluating Schedule”, a chart is displayed with the title “Are we in danger of slipping our schedule?” The classified attributes displayed on this chart are open date on one axis and the status on the other.

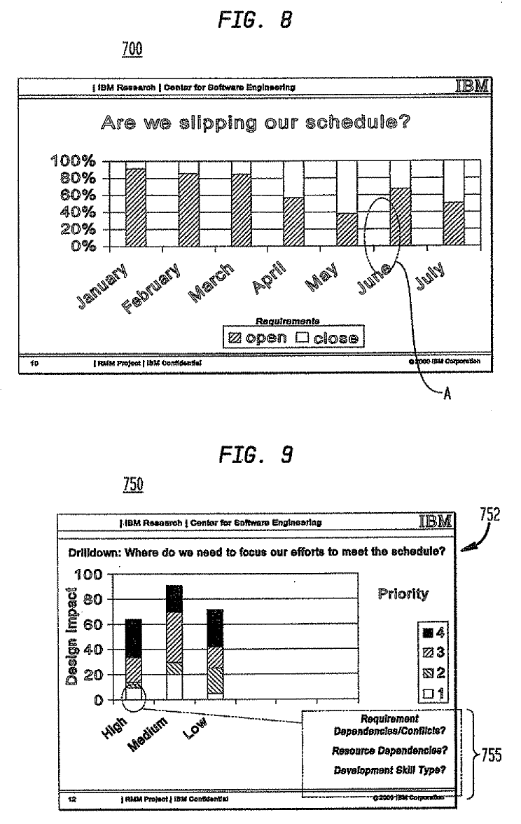

FIGS. 8-10 provide an example of how the schedule might be evaluated and how risk of the current set of requirements on that schedule may be determined based on the example selection of analysis task/category “Evaluating Schedule”. FIG. 8 particularly provides a bar chart 700 indicating for the Evaluating Schedule example the status of requirements (Frequency of Requirements) opened and closed for on a monthly basis (Open Date). As shown in FIG. 8, from January to May, there is exhibited a steady decline in the number of requirements opened each month while the number of requirements closed has increased. This is what may be desirable as the software development cycle progresses forward. However, in June, there's a sudden increase in the number of requirements opened, shown as label “A”. This could be an indication that the risk of the project has just increased and that the schedule may be slipping.

In the example schedule depicted in FIG. 8, due to the sudden increase in the new requirements as was exhibited in June, a risk assessment may be triggered. In order to assess the risk and determine whether the schedule is slipping, a more drilled down focus is made on those requirements that were opened in June. FIG. 9 depicts an Evaluating Schedule interface 750 depicting an example plot of the Design. Impact for Month of June (on the “X” axis), verses the Priority for those requirements (on the “Y” axis). In FIG. 9, the 750 chart showing the design impact and priority for those requirements reveals a subset of requirements that should be investigated in order to determine where efforts need to be focused in order to meet the schedule. Efforts need to be focused on those new requirements that have a priority of 1 which means they have a high priority and a greater design impact because the effort to design and test those requirements with high design impact is greater than those with medium, or low. Some of the issues 755 that may be investigated before answering the title question 752, e.g., “Where do we need to focus our efforts to meet the schedule?” might be 1) what other requirements is this set (set of high priority and high design impact) of requirement dependent on? 2) Which resources are we dependent on for these requirements 3) what development skills are necessary to implement the requirements with high priority and high design impact?

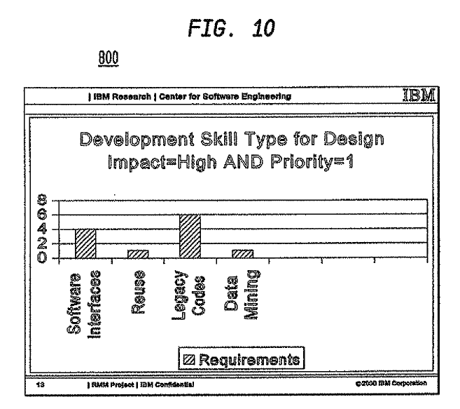

FIG. 10 depicts an example Evaluating Schedule plot 800 that comprises a more drilled down focus of FIG. 9 showing Development Skill Types for Design Impact=High and Priority=1. In FIG. 10, a focus is being made as to the development skill types required for the requirements shown in red circle in FIG. 9—those requirements with a high design impact and high priority. Thus FIG. 10 indicates that if it is desired to meet the schedule, efforts need to be focused on getting skills in legacy code, software interfaces, reuse, and data mining—in that order of priority.

It should be understood that further topics for analysis and interpretation that may be performed according to the RMM of the present invention include, but are not limited to. Risk of an individual software feature, Risk of an individual software requirement, Evaluating workload and productivity, Evaluating schedule, Evaluating Return on Investment, Evaluating strength and weaknesses of the requirements process, Evaluating strength and weaknesses of the development process, Understanding the customer's Deeds, Evaluating project management.

The present invention has been described with reference to diagrams of methods, apparatus (systems) and computer program products according to embodiments of the invention. It will be understood that each diagram can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified herein.

These computer program instructions may also be stored in a computer-readable memory that can direct a computer or other programmable data processing apparatus to function in a particular manner, such that the instructions stored in the computer-readable memory produce an article of manufacture including instruction means which implement the functions specified herein.

The computer program instructions may also be loaded onto a computer-readable or other programmable data processing apparatus to cause a series of operational steps to be performed on the computer or other programmable apparatus to produce a computer implemented process such that the instructions which execute on the computer or other programmable apparatus provide steps for implementing the functions specified herein.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

Having thus described our invention, what we claim as new, and desire to secure by Letters Patent is:

1. A requirements management methodology comprising:
automatically collecting requirements related data and metrics associated with one or more of user needs, features, and requirements;
classifying requirements related data and metrics according to one or more attributes and associated attribute values for storage in a memory storage device;
receiving user requests concerning a requirements topic; and,
in response to received user requests:
accessing said classified requirements related data from said memory storage device and analyzing relationships of attributes to one or more analysis task categories associated with a requirements topic; and,
providing information to the user according to a particular requirements topic based on results of said analyzing, wherein users are enabled to assess requirements and identify a course of action for improving requirements.

2. The requirements management methodology as claimed in claim 1, wherein said analyzing comprises: applying rules to classified requirements related data for specifying the relationship between attributes and task categories, a task category having associated one or more requirement topics.

3. The requirements management methodology as claimed in claim 2, wherein a task category includes one or more selected from: Evaluating Productivity/workload; Evaluating Schedule; Identifying Strengths and Weaknesses in the Requirements Process; Understanding a Customers' Needs; and Evaluating Project Management.

4. The requirements management methodology as claimed in claim 3, wherein said providing information to the user comprises: automatically generating a chart to visualize analysis and interpretation of results.

5. The requirements management methodology as claimed in claim 4, wherein a generated chart addresses a set of questions to guide assessment of a task category.

6. The requirements management methodology as claimed in claim 5, wherein said analyzing comprises: querying the memory storage device for data values associated with one or more attributes related to the questions associated for that task category.

7. The requirements management methodology as claimed in claim 4, wherein users are enabled to assess requirements and identify project risk when requirements change.

8. The requirements management methodology as claimed in claim 4, wherein said requirement related data includes one or more attributes selected from: business impact, user needs, features, and requirements; customer importance and development priority of requirements related data; estimated and actual cost and effort of requirement; dependencies/conflicts between requirements, resources necessary for requirement; creation date, freeze date, date of last revision, approval date; development skill type needed to implement; customer benefits of implementing requirement, qualifier; type; descriptor; stakeholder source; unique id; phase proposed, phase implemented, release implemented; difficulty, design impact, stability, and status.

9. The requirements management methodology as claimed in claim 8, wherein requirement related data and metrics are captured throughout a product development lifecycle.

10. The requirements management methodology as claimed in claim 9, further comprising: implementing mechanism providing a link between queries of requirements related data and predefined tasks.

11. The requirements management methodology as claimed in claim 1, adapted for providing diagnostics for both the requirements and the development process.

12. The requirements management methodology as claimed in claim 1, adapted to utilize collected requirement metrics to provide a guideline for creating more complete requirements with enhanced accuracy.

13. The requirements management methodology as claimed in claim 1, adapted to utilize manage requirements change.

14. A system for managing requirements for a user comprising:
means for automatically collecting requirements related data and metrics associated with one or more of user needs, features, and requirements;
a memory storage device for storing said collected requirement related data and metrics;
means for executing logic for classifying requirements related data and metrics according to one or more attributes and associated attribute values for storage in said memory storage device;
means for receiving user queries concerning a requirements topic; and,
a data analysis means for accessing said classified requirements related data from said memory storage device and analyzing relationships of attributes to one or more analysis task categories associated with a requirements topic in response to a received user query; said data analysis means for providing information to the user according to a particular requirements topic based on results of said analyzing, wherein users are enabled to assess requirements and identify a course of action for improving requirements.

15. The system as claimed in claim 14, wherein said means for accessing and analyzing classified requirements related data comprises: means implementing logic for applying rules to classified requirements related data for specifying the relationship between attributes and task categories, a task category having associated one or more requirement topics.

16. The system as claimed in claim 15, wherein a task category includes one or more selected from: Evaluating Productivity/workload; Evaluating Schedule; Identifying Strengths and Weaknesses in the Requirements Process; Understanding a Customers' Needs; and Evaluating Project Management.

17. The system as claimed in claim 16, wherein said means for providing information to the user comprises: means for automatically generating a chart to visualize analysis and interpretation of results, a generated chart addressing a set of questions to guide assessment of a task category.

18. The system as claimed in claim 17, wherein users are enabled to assess requirements and identify project risk when requirements change.

19. The system as claimed in claim 17, wherein said means for executing logic for classifying requirements related data and metrics, accesses rules for classification, parses each record and assigns values for each attribute in the record according to a classification scheme, said memory storage device storing user records having classified attributes as they relate to one of: user needs features and requirements.

20. The system as claimed in claim 19, wherein said data analysis means accesses said classified requirements related data from the memory storage device, along with any other metrics pertaining to the set of records to be analyzed and performs the analysis on a specified subset of records based on a received user request.

21. The system as claimed in claim 20, wherein said data analysis means provides an indicator as to the risk of changing a specific request and help determine resources needed for implementation a requirements change.

22. A program storage device readable by a machine, tangibly embodying a program of instructions executable by the machine to perform method steps for requirements management, said method comprising steps of:
automatically collecting requirements related data and metrics associated with one or more of user needs, features, and requirements;
classifying requirements related data and metrics according to one or more attributes and associated attribute values for storage in a memory storage device;
receiving user requests concerning a requirements topic; and,
in response to received user requests:
accessing said classified requirements related data from said memory storage device and analyzing relationships of attributes to one or more analysis task categories associated with a requirements topic; and,
providing information to the user according to a particular requirements topic based on results of said analyzing, wherein users are enabled to assess requirements and identify a course of action for improving requirements.

23. The program storage device readable by a machine as claimed in claim 22, wherein method steps for implementing said analyzing comprises: applying rules to classified requirements related data for specifying the relationship between attributes and task categories, a task category having associated one or more requirement topics.

24. The program storage device readable by a machine as claimed in claim 22, wherein a task category includes one or more selected from: Evaluating Productivity/workload; Evaluating Schedule; Identifying Strengths and Weaknesses in the Requirements Process; Understanding a Customers' Needs; and Evaluating Project Management.

25. A method of deploying a computer program product for managing requirements for a business entity comprising:
collecting requirements related data and metrics associated with one or more of needs, features, and requirements of the business entity;
classifying requirements related data and metrics according to one or more attributes and associated attribute values for storage in a memory storage device;
receiving requests from the business entity concerning a requirements topic; and,
in response to received request:
accessing said classified requirements related data from said memory storage device and analyzing relationships of attributes to one or more analysis task categories associated with a requirements topic; and,
providing information to the business entity according to a particular requirements topic based on results of said analyzing, wherein said business entity is enabled to assess requirements and identify a course of action for improving requirements.

26. A computer program product comprising a computer usable medium readable by a digital processing apparatus and tangibly embodying a program of instructions comprising computer readable program code means executable by the digital processing apparatus to perform method steps for managing a software development project for a business entity, the method steps comprising:
collecting requirements related data and metrics associated with one or more of needs, features, and requirements of the business entity;
classifying requirements related data and metrics according to one or more attributes and associated attribute values for storage in a memory storage device;
receiving requests from a business entity concerning a requirements topic; and,
in response to received request:
accessing said classified requirements related data from said memory storage device and analyzing relationships of attributes to one or more analysis task categories associated with a requirements topic; and,
providing information to the business entity according to a particular requirements topic based on results of said analyzing, wherein said business entity is enabled to assess requirements and identify a course of action for improving requirements.
